(19) United States
(12) Patent Application Publication
(10) Pub. No.: US 2019/0308669 A1
(43) Pub. Date: Oct. 10, 2019

(54) COMPOSITE UNDERBODY STRUCTURE FOR VEHICLES

(71) Applicants: GM GLOBAL TECHNOLOGY OPERATIONS LLC, Detroit, MI (US); CONTINENTAL STRUCTURAL PLASTICS, INC, Auburn Hills, MI (US)

(72) Inventors: Venkateshwar R. AITHARAJU, Troy, MI (US); Satvir AASHAT, Sterling Heights, MI (US); William R. RODGERS, Bloomfield Township, MI (US); Teresa U. HOLINESS-STALLING, Detroit, MI (US); Marc-Philippe TOITGANS, Pouance (FR); Adam BURLEY, Auburn Hills, MI (US)

(73) Assignees: GM GLOBAL TECHNOLOGY OPERATIONS LLC, Detroit, MI (US); CONTINENTAL STRUCTURAL PLASTICS, INC, Auburn Hills, MI (US)

(21) Appl. No.: 15/947,406

(22) Filed: Apr. 6, 2018

(51) Int. Cl. B62D 25/20; B62D 29/04; B62D 21/15

(52) U.S. Cl. CPC B62D 25/20; B62D 21/02; B62D 21/15; B62D 29/041

(57) ABSTRACT

An underbody assembly for a vehicle includes a plurality of polymer-fiber composite components. The polymer-fiber composite components include a base and a first reinforcement. The base includes a first side and a second side. The base is configured to extend in a longitudinal direction between a front of the vehicle and a rear of the vehicle. The first reinforcement is coupled to the base. The first reinforcement includes a first elongated ridge and a first elongated trough. The first elongated trough is disposed adjacent to the first elongated ridge. The first elongated ridge and the first elongated trough each extend transversely between the first side of the base and the second side of the base. In various aspects, the underbody assembly consists essentially of the polymer-fiber composite components.

### GOVERNMENT SUPPORT

This invention was made with government support under DE-FOA-0000991 awarded by the Department of Energy. The Government has certain rights in the invention.

### INTRODUCTION

This section provides background information related to the present disclosure which is not necessarily prior art.

The present disclosure relates to a composite underbody structure for vehicles.

Vehicle underbody assemblies provide structural support and mounting locations for other vehicle components. Underbody assemblies may include or be coupled to energy-absorbing components, such as rocker assemblies on opposing sides of the vehicle. Typical underbody assemblies may include a large quantity of metal components and be relatively heavy. However, it is advantageous that components of automobiles or other vehicles be lightweight to improve fuel efficiency. Thus, vehicle components, such as underbody assemblies, that exhibit both adequate strength during normal service and energy-absorption characteristics under extraordinary conditions such as collisions, while minimizing component weight are advantageous.

### SUMMARY

This section provides a general summary of the disclosure, and is not a comprehensive disclosure of its full scope or all of its features.

In certain aspects, the present disclosure provides an underbody assembly for a vehicle. The underbody assembly includes polymer-fiber composite components. The polymer-fiber composite components include a base and a first reinforcement. The base includes a first side and a second side. The base is configured to extend in a longitudinal direction between a front of the vehicle and a rear of the vehicle. The first reinforcement is coupled to the base. The first reinforcement includes a first elongated ridge and a first elongated trough. The first elongated trough is disposed adjacent to the first elongated ridge. The first elongated ridge and the first elongated trough each extend transversely between the first side of the base and the second side of the base.

In one aspect, the first elongated trough engages a surface of the base. The first elongated ridge cooperates with the surface to define an elongated cell. The elongated cell is disposed between the first elongated ridge and the base.

In one aspect, the base includes a first region defining a first thickness and a second region defining a second thickness. The second thickness is greater than the first thickness.

In one aspect, the polymer-fiber composite of the base includes a first fiber architecture. The polymer-fiber composite of the first reinforcement includes a second fiber architecture that is distinct from the first fiber architecture.

In one aspect, the base further includes an elongated raised portion. The elongated raised portion is disposed between a first portion of the base and a second portion of the base. The elongated raised portion defines a longitudinal tunnel extending in the longitudinal direction.

In one aspect, the first elongated ridge and the first elongated trough each extend between the first side of the base and the elongated raised portion. The polymer-fiber composite components further include a second reinforcement. The second reinforcement is coupled to the base and includes a second elongated ridge and a second elongated trough. The second elongated trough is disposed adjacent to the second elongated ridge. The second elongated ridge and the second elongated trough each extend transversely between the elongated raised portion and the second side of the base.

In one aspect, the first reinforcement further includes a first end wall, a second end wall, a first reinforcement flange, and a second reinforcement flange. The first elongated ridge and the first elongated trough each extend between the first end wall and the second end wall. The first reinforcement flange projects from the first end wall and the second reinforcement flange projects from the second end wall. The first reinforcement flange and the second reinforcement flange engage the base to couple the first reinforcement to the base.

In one aspect, the first elongated ridge is configured to be coupled to a seat of the vehicle.

In one aspect, the first elongated ridge includes a plurality of first elongated ridges. The plurality of first elongated ridges includes 1-6 first elongated ridges. The first elongated trough includes a plurality of first elongated troughs. The first elongated troughs are alternatingly disposed with the first elongated ridges in the longitudinal direction.

In one aspect, the polymer-fiber composite components further include a first rocker subassembly and a second rocker subassembly. The first rocker subassembly is coupled to the first side of the base. The first rocker subassembly includes a first elongated housing and a first energy-absorbing element. The first elongated housing defines a first interior compartment. The first energy-absorbing element is disposed within the first interior compartment. The second rocker subassembly is coupled to the second side of the base. The second rocker subassembly includes a second elongated housing and a second energy-absorbing element. The second elongated housing defines a second interior compartment. The second energy-absorbing element is disposed within the second interior compartment.

In one aspect, the first energy-absorbing element includes a plurality of first energy-absorbing elements. Each first energy-absorbing element includes a first elongated hollow structure defining a substantially round cross section. The second energy-absorbing element includes a plurality of second energy-absorbing elements. Each second energy-absorbing element includes a second elongated hollow structure defining a substantially round cross section.

In one aspect, the first rocker subassembly further includes a third energy-absorbing element. The first elongated housing further defines a third interior compartment. The third energy-absorbing element is disposed within the third interior compartment. The second rocker subassembly further includes a fourth energy-absorbing element. The second elongated housing further defines a fourth interior compartment. The fourth energy-absorbing element is disposed within the fourth interior compartment.

In one aspect, the base and the first reinforcement include distinct polymer-fiber composite materials.

In one aspect, the polymer-fiber composites of the base and the first reinforcement each include multiaxial continuous fiber non-crimp fabrics.

In certain other aspects, the present disclosure provides an underbody assembly for a vehicle. The underbody assembly consists essentially of polymer-fiber composite components. The polymer-fiber composite components include a base, a first rocker subassembly, and a second rocker subassembly. The base is configured to extend in a longitudinal direction between a front of the vehicle and a rear of the vehicle. The base includes a first side, a second side, and an elongated raised portion. The elongated raised portion defines a longitudinal tunnel and extends in the longitudinal direction between the front of the vehicle and the rear of the vehicle. The base includes a first region defining a first thickness and a second region defining a second thickness. The second thickness is greater than the first thickness. The first rocker subassembly is coupled to the first side of the base. The first rocker subassembly includes a first elongated housing and a first energy-absorbing element. The first elongated housing defines a first interior compartment. The first energy-absorbing element is disposed within the first interior compartment. The second rocker subassembly is coupled to the second side of the base. The second rocker subassembly includes a second elongated housing and a second energy-absorbing element. The second elongated housing defines a second interior compartment. The second energy-absorbing element is disposed within the second interior compartment.

In one aspect, the second region is at least partially disposed on the elongated raised portion. The base further includes a third region and a fourth region. The third region has a third thickness greater than the first thickness. The third region is disposed adjacent to the first side of the base. The fourth region has a fourth thickness greater than the first thickness. The fourth thickness is disposed adjacent to the second side of the base.

In yet other aspects, the present disclosure provides a method of manufacturing an underbody assembly for a vehicle. The method includes forming a base including a polymer-fiber composite. The base includes a first side and a second side. The base is configured to extend in a longitudinal direction between a front of the vehicle and a rear of the vehicle. The method further includes forming a reinforcement including a polymer-fiber composite. The reinforcement includes an elongated ridge and an elongated trough. The elongated trough is disposed adjacent to the elongated ridge. The method further includes coupling the reinforcement to the base so that the elongated ridge extends transversely between the first side of the base and the second side of the base.

In one aspect, the coupling the reinforcement to the base includes disposing a layer of adhesive between the base and the reinforcement, and curing the adhesive.

In one aspect, the forming the base and the forming the reinforcement each include a process selected from the group consisting of: resin transfer molding (RTM), high-pressure resin transfer molding (HP-RTM), compression resin transfer molding (C-RTM), vacuum assisted resin transfer molding (VARTM), compression molding, autoclave, and combinations thereof.

In one aspect, the method further includes forming a first elongated rocker component, a second elongated rocker component, a third elongated rocker component, and a fourth elongated rocker component. The method further includes coupling the first elongated rocker component to the first side of the base. The method further includes coupling the second elongated rocker component to the second side of the base. The method further includes coupling the third elongated rocker component to the first elongated rocker component. The first elongated rocker component and the third elongated rocker component cooperate to define a first interior compartment. The method further includes coupling the fourth elongated rocker component to the second elongated rocker component. The second elongated rocker component and the fourth elongated rocker component cooperate to define a second interior compartment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C show an underbody assembly according to certain aspects of the present disclosure; FIG. lA is an isometric view of the underbody assembly; FIG. 1B is a sectional view of the underbody assembly taken at line 1B-1B of FIG. 1A; FIG. 1C is a sectional view of the underbody assembly taken at line 1C-1C of FIG. 1A;

FIGS. 2A-2B show a base for an underbody assembly according to certain aspects of the present disclosure; FIG. 2A is an isometric view of the base; FIG. 2B is a sectional view of the base taken at line 2B-2B of FIG. 2A;

FIGS. 3A-3C show another underbody assembly according to certain aspects of the present disclosure; FIG. 3A is an isometric view of the underbody assembly; FIG. 3B is a sectional view of the underbody assembly taken at line 3B-3B of FIG. 3A; FIG. 3C is a sectional view of the underbody assembly taken at line 3C-3C of FIG. 3A;

FIG. 4 is a partial sectional view of an underbody assembly having a base and a reinforcement according to certain aspects of the present disclosure;

FIG. 5 is a partial sectional view of another underbody assembly having a base and a reinforcement according to certain aspects of the present disclosure;

FIG. 6 is a partial sectional view of yet another underbody assembly having a base and a reinforcement according to certain aspects of the present disclosure;

FIG. 7 is a partial sectional view of yet another underbody assembly having a base and a reinforcement according to certain aspects of the present disclosure;

FIG. 8 is a partial sectional view of an underbody assembly having a base and a rocker subassembly according to certain aspects of the present disclosure; and

FIG. 9 is a partial sectional view of another underbody assembly having a base and a rocker subassembly according to certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

As discussed above, vehicle underbody assemblies provide structural support and mounting locations for other vehicle components. Underbody assemblies may include or be coupled to energy-absorbing components, such as rocker assemblies. Many underbody assemblies consist entirely of metal components, such as steel components. These underbody assemblies may be referred to as metal underbody assemblies. Metal underbody assemblies commonly include over eighty distinct components. The high quantity of components may be at least partially due to a desire to increase strength in high-stress regions of the underbody assembly. Due to the quantity of distinct components, manufacturing and assembling a metal underbody assembly may be complex and time-intensive. Moreover, metal underbody assemblies may be heavy, leading to decreased fuel economy in the vehicle. Some other underbody assemblies may include both lighter-weight composite components and metal structural components. The metal structural components, such as cross members, may be necessary to achieve a desired side impact strength. These underbody assemblies may be referred to as metal-and-composite underbody assemblies.

In various aspects, the present disclosure provides an underbody assembly for a vehicle that consists essentially of polymer-fiber composite components (the “composite underbody assembly”). The composite underbody assembly may generally include a base and a reinforcement. The base may be disposed on the underside of the vehicle and may include a first side and a second side opposite the first side. The base may extend in a longitudinal direction between a front of the vehicle and a rear of the vehicle. The reinforcement may be coupled to the base to provide additional structural support and improve performance during a side impact. The reinforcement may include an elongated ridge and an elongated trough. The elongated ridge and the elongated trough may be disposed adjacent to one another and may each extend transversely between the first side of the base and the second side of the base.

The composite underbody assembly may generally be less complex than the metal underbody assembly, including far fewer components (e.g., a nine-component composite underbody assembly may include: a base; first and second reinforcements; and first and second rocker assemblies having three components each). The base, the reinforcements, and/or the rocker assemblies may include walls defining a variable thickness, such as an increased thickness at regions of high expected stress. The composite underbody assembly may also include a rocker subassembly disposed at each side, each rocker subassembly having a housing and one or more internal energy-absorbing elements. The base, reinforcements, housings, and energy-absorbing elements may all be formed from or include a polymer-fiber composite material. The polymer-fiber composite components may be joined to one another with adhesive to minimize stress concentration at joints and reduce a quantity of components (e.g., eliminate or reduce a quantity of fasteners).

In certain aspects, the composite underbody assembly of the present disclosure may be light weight compared to the metal underbody assembly. The ability to form composite structures with variable thickness may facilitate consolidation of structural components. For example, where the typical metal underbody assembly includes distinct reinforcing components at each high stress area, the composite underbody assembly of the present disclosure may instead define regions of increased thickness at the high-stress areas. Thus, thickness can also be minimized at lower stress regions for additional weight reduction.

In contrast to the metal-and-composite underbody assembly, the composite underbody assembly of the present disclosure may consist essentially of polymer-fiber composite components such that it is free of metal structural components. The composite underbody assembly may exhibit sufficient side impact strength without the inclusion of metal structural members because of the thickened regions and/or the composite reinforcements having the transverse ridges. The components of the composite-intensive design may be fabricated in high-volume composite manufacturing processes. The decreased quantity of components compared to typical underbody designs (e.g., the metal underbody assembly or the metal-and-composite underbody assembly) may also lead to a relatively simple assembly process.

Each of the polymer-fiber composite structural components (e.g., the base, the first reinforcement, and the second reinforcement) may include a polymer and a plurality of reinforcing fibers. The polymer-fiber composite structural components may be the same or different. Different polymer-fiber composites may include one or more of: distinct polymers, fibers having different compositions (e.g., carbon and glass), differently-fabricated fibers (e.g., woven fabric and discontinuous random fibers), and different volume fractions of reinforcing fiber.

The polymer may be any suitable thermoplastic resin or thermoset resin. The thermoplastic resin may include: vinyl chloride resin, vinylidene chloride resin, vinyl acetate resin, polyvinyl alcohol resin, polystyrene resin, acrylonitrile styrene resin, acrylonitrile-butadiene-styrene resin, acrylic resin, methacrylate resin, polyethylene resin, polypropylene resin, polyamide resin (PA6, PA11, PA12, PA46, PA66, PA610), fully or partially aromatic polyamide resins, polyacetal resin, polycarbonate resin, polyethylene terephthalate resin, polyethylene naphthalate resin, polybutylene terephthalate resin, polyacrylate resin, polyphenylene ether resin, polyphenylene sulfide resin, polysulfone resin, polyether sulfone resin, polyether ether ketone resin, polylactide resin, or any combination or copolymer of these resins. The thermoset resin may include: benzoxazine, a bis-maleimide (BMI), a cyanate ester, an epoxy, a phenolic (PF), a polyacrylate (acrylic), a polyimide (PI), an unsaturated polyester, a polyurethane (PUR), a vinyl ester, a siloxane, or any combination or copolymer of these resins.

The reinforcing fibers may include: carbon fibers, glass fibers (e.g., fiber glass, quartz), basalt fibers, aramid fibers (e.g., TWARON®, sold by Teijin Aramid B.V), polyphenylene benzobisoxazole (PBO) fibers, polyethylene fibers (e.g., ultra-high molecular weight polyethylene (UHMWPE)), polypropylene fibers (e.g., high-strength polypropylene), natural fibers (e.g., cotton, flax, cellulose, spider silk), and combinations thereof, by way of example. The reinforcing fibers may be fabricated as woven fabric, continuous random fabric, discontinuous random fibers, chopped random fabric, continuous strand unidirectional plies, multiaxial continuous fiber non-crimp fabrics, oriented chopped strand plies, braided fabric, and combinations thereof, by way of example. In various aspects, each polymer-fiber composite structural component includes multiaxial continuous fiber non-crimp fabric.

The polymer-fiber composite components can be joined to one another by adhesive. Suitable adhesives include adhesives based on methacrylate resins, urethane resins, or epoxy resins, by way of example. As appreciated by those of skill in the art, the composite material may further include other conventional ingredients, including other reinforcement materials, functional fillers or additive agents, like organic/inorganic fillers, fire-retardants, anti-ultraviolet radiation agents (UV stabilizers), anti-oxidants, colorants, mold release agents, softeners, plasticizing agents, surface active agents, and the like.

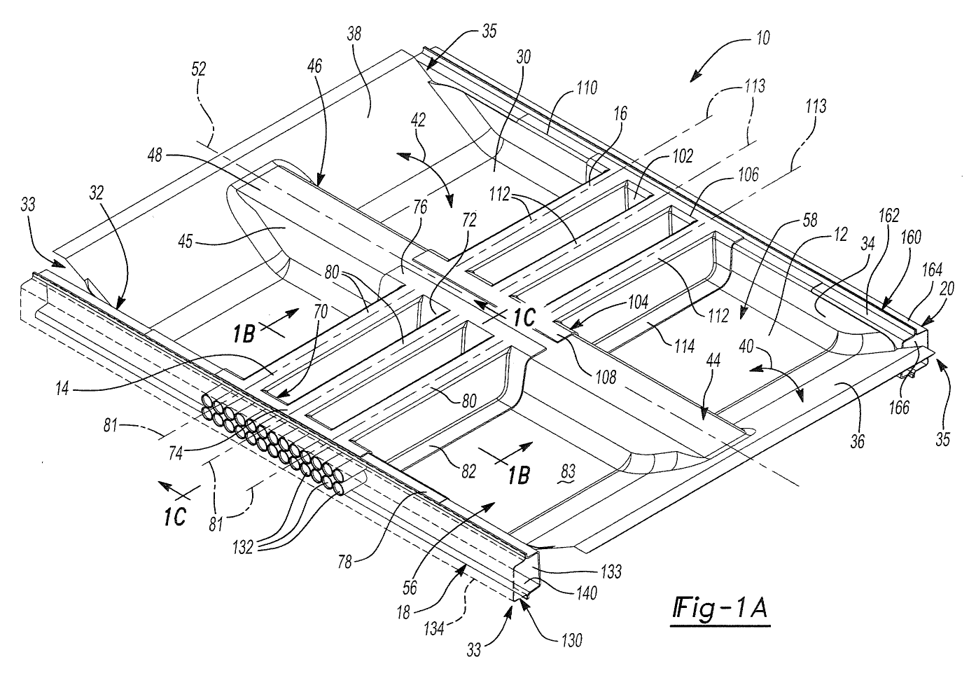

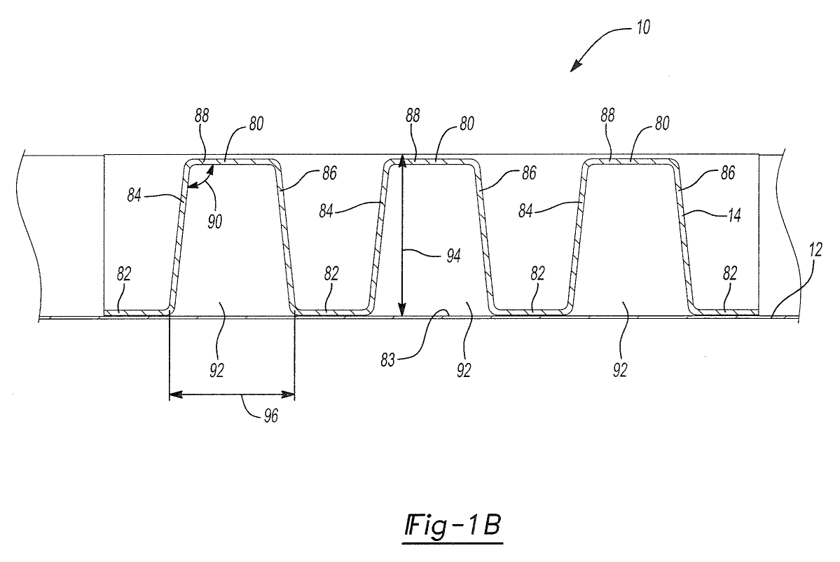

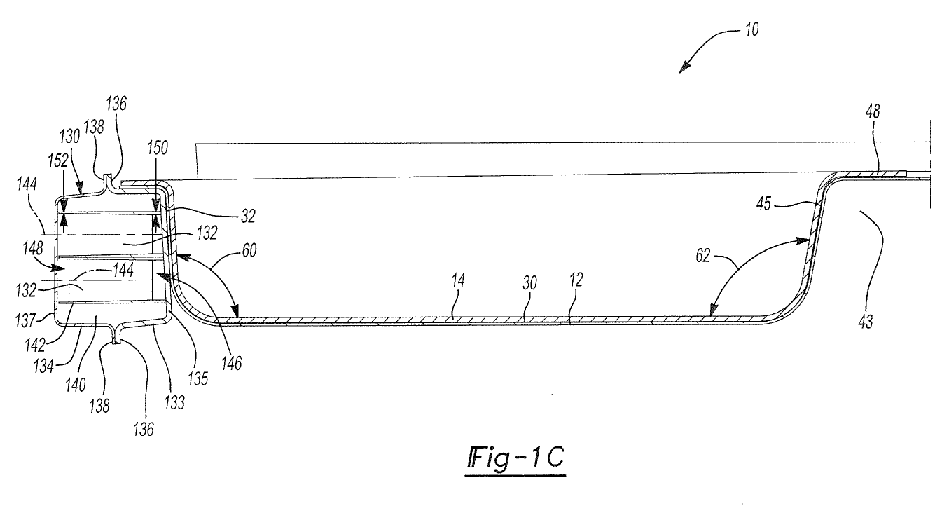

Referring to FIGS. 1A-1C, an underbody assembly 10 for a vehicle according to certain aspects of the present disclosure is provided. The underbody assembly 10 may include a plurality of polymer-fiber composite components. The polymer-fiber composite components may be or include a base 12, a first reinforcement 14, and a second reinforcement 16. In certain variations, the underbody assembly 10 may also include a first rocker subassembly 18 and a second rocker subassembly 20. The first and second rocker subassemblies 18, 20 may include multiple components, as will be described in greater detail below.

The underbody assembly 10 may consist essentially of polymer-fiber composite components. In various aspects, the underbody assembly 10 is free of structural components that are formed from or include metal, such as metal crossbeams. Thus, in various aspects, the underbody assembly 10 consists essentially of polymer-fiber composite structural components. However, the underbody assembly 10 may optionally include non-structural metal components, such as fasteners and other hardware. In certain aspects, the underbody assembly 10 consists essentially of the base 12, the first reinforcement 14, the second reinforcement 16, the first rocker subassembly 18, and the second rocker subassembly 20. The polymer-fiber composite components (e.g., the base 12, the first and second reinforcements 14, 16, and the first and second rocker subassemblies 18, 20) may be adhesively joined to one another to form the underbody assembly 10. In various aspects, adhesive joining of the composite components facilitates the formation of joints having lower stress concentrations as compared to joints including only mechanical fasteners.

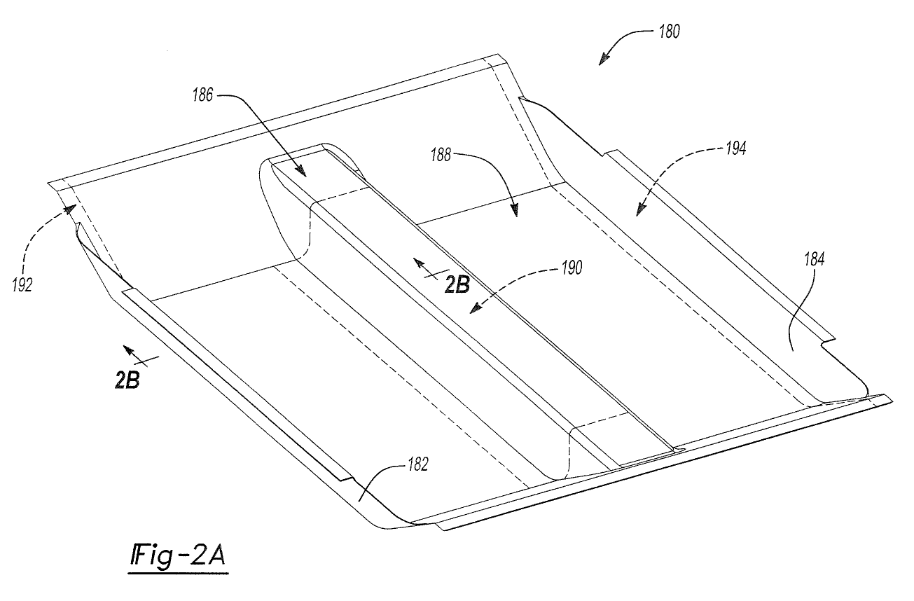

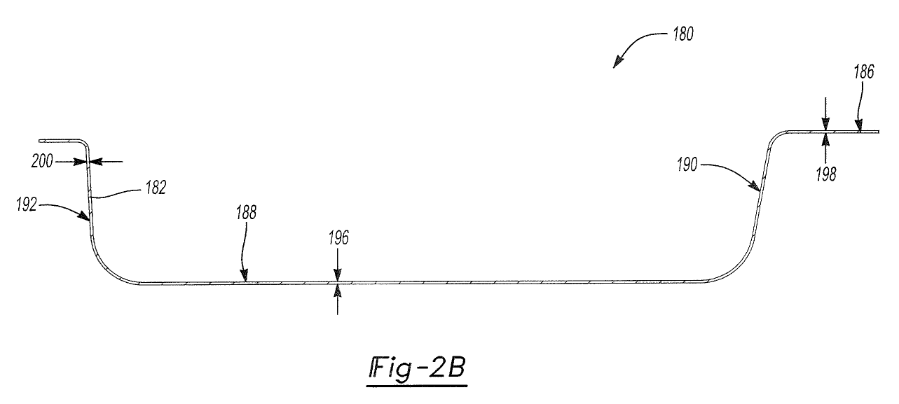

An example base is shown in FIG. 2A without first and second reinforcements coupled thereto (see base 180). Returning to FIGS. 1A-1C, the base 12 may extend longitudinally from a front of the vehicle to a rear of the vehicle and between first and second sides of the vehicle (e.g., a driver side and a passenger side). The base 12 may be disposed on the underside of the vehicle, such as beneath a floor of the passenger cabin of the vehicle. The base 12 may provide structural support and mounting locations for other vehicle components. The base 12 may have a unibody construction (i.e., be a single piece). However, in various alternative aspects, the base 12 is formed from or includes multiple pieces. By way of example, the base 12 may include two pieces separated by a seam extending from the first side of the vehicle to the second side of the vehicle, such that the two pieces may include a front piece and a rear piece.

The base 12 may include a support floor or bottom wall 30. In various aspects, the bottom wall 30 is substantially planar. The base 12 may further include a first outer wall 32 disposed adjacent to a first side 33 of the base 12 and a second outer wall 34 disposed adjacent to a second side 35 of the base 12. The first and second outer walls 32, 34 may extend longitudinally. The first outer wall 32 may be disposed at or near the first side of the vehicle (e.g., a passenger side) and the second outer wall 34 may be disposed opposite the first outer wall 32, at or near a second side of the vehicle (e.g., a driver side).

The base 12 may also include a first angled wall or a front wall 36 and a second angled wall or rear wall 38. A front angle 40 may be defined between the front wall 36 and the bottom wall 30. The front angle 40 may be greater than or equal to about 20° to less than or equal to about 90°, optionally greater than or equal to about 30° to less than or equal to about 80°, optionally greater than or equal to about 40° to less than or equal to about 75°, and optionally greater than or equal to about 45° to less than or equal to about 55°. A rear angle 42 may be defined between the rear wall 38 and the bottom wall 30. The rear angle 42 may be greater than or equal to about 20° to less than or equal to about 90°, optionally greater than or equal to about 30° to less than or equal to about 75°, optionally greater than or equal to about 40° to less than or equal to about 60°, and optionally greater than or equal to about 45° to less than or equal to about 50°. The front angle 40 and the rear angle 42 may have the same magnitude or different magnitudes.

In various aspects, the base 12 further defines a longitudinal tunnel 43 (FIG. 1C) extending between the front of the vehicle and the rear of the vehicle. The longitudinal tunnel 43 may provide space for other vehicle components and systems, such as a transmission, by way of example. The longitudinal tunnel 43 may be open on a bottom side (i.e., a side facing the ground when the underbody assembly 10 is coupled to the vehicle that engages the ground). In certain aspects, the longitudinal tunnel 43 may be centered between the first and second sides of the vehicle.

Although the base 12 of FIGS. 1A-1C includes the longitudinal tunnel 43, in alternative aspects, the longitudinal tunnel 43 may be omitted. For example, the longitudinal tunnel 43 may be omitted when it is not necessary for vehicle component packaging (e.g., for an electric vehicle without a transmission). When the longitudinal tunnel 43 is omitted, the bottom wall 30 may extend between the first outer wall 32 and the second outer wall 34, with the first and second portions 56, 58 being substantially coplanar. In other alternative aspects, the base 12 may include other raised portions, depressions, angled walls, and/or curved walls depending on the vehicle and packaging requirements.

The longitudinal tunnel 43 may be at least partially defined by an elongated raised portion 44 including a first inner wall 45, a second inner wall 46, and an upper wall 48 extending between the first inner wall 45 and the second inner wall 46. The first inner wall 45, the second inner wall 46, and the upper wall 48 may cooperate to define the elongated raised portion 44. The elongated raised portion 44 may extend along a longitudinal axis 52. The elongated raised portion 44 may be disposed between a first portion 56 of the base 12 and a second portion 58 of the base 12.

As best shown in FIG. 1C, the first outer wall 32 may form an outside angle 60 with the bottom wall 30. The outside angle 60 may be greater than or equal to about 90° to less than or equal to about 110°, optionally greater than or equal to about 90° to less than or equal to about 100°, and optionally greater than or equal to about 93° to less than or equal to about 100°, by way of example. The second outer wall 34 may form the outside angle 60 with the bottom wall 30. The first inner wall 45 may form an inside angle 62 with the bottom wall 30. The inside angle 62 may be greater than or equal to about 90° to less than or equal to about 120°, greater than or equal to about 93° to less than or equal to about 110°, and optionally greater than or equal to about 100° to less than or equal to about 110°, by way of example. The second inner wall 46 may form the inside angle 62 with the bottom wall 30. In certain aspects, the base 12 may define a W-shaped cross section in a side-to-side direction with respect to the vehicle (i.e., from the first side of the vehicle to the second side of the vehicle).

Returning to FIG. 1A, the first and second reinforcements 14, 16 may be coupled to the base 12 to provide additional structural support, particularly for the first and second rocker subassemblies 18, 20 in the case of side impacts. The first reinforcement 14 may include a first end wall 70 and a second end wall 72. The first end wall 70 may engage the first outer wall 32 of the base 12. The second end wall 72 may engage the first inner wall 45 of the base 12. The first reinforcement 14 may further include a first reinforcement flange 74 and a second reinforcement flange 76. The first reinforcement flange 74 may project from the first end wall 70 away from the second end wall 72. The second reinforcement flange 76 may project from the second end wall 72 away from the first end wall 70. The first reinforcement flange 74 may engage a first base flange 78 that extends from the first outer wall 32 of the base 12 away from the second side 35 of the base 12. The second reinforcement flange 76 may engage the upper wall 48 of the base 12.

The first reinforcement 14 may be fixed to the base 12 at the first and second reinforcement flanges 74, 76. More particularly, adhesive may be disposed between each of the first and second reinforcement flanges 74, 76 and the base 12. The relatively large surface area of the joints may facilitate lower stress concentrations compared to joints including only mechanical fasteners. Furthermore, the first and second reinforcement flanges 74, 76 can be sized to effectively transfer the expected side impact loads. Advantageously, the polymer-fiber composite construction of the first reinforcement 14 allows the first and second reinforcement flanges 74, 76 to be manufactured as continuous flanges, which would not be feasible with the typical manufacturing processes used for metal underbody assemblies.

The first reinforcement 14 may include at least one first elongated ridge, which may be a plurality of first elongated ridges 80. Each first elongated ridge 80 may define and extend along a respective first transverse axis 81. The first reinforcement 14 may also include at least one first elongated trough, which may be plurality of first elongated troughs 82. Each first elongated ridge 80 may be disposed adjacent to a first elongated trough 82. The plurality of first elongated ridges 80 and the plurality of first elongated troughs 82 may extend transversely between the first side 33 of the base 12 and the second side 35 of the base 12 (e.g., between the first outer wall 32 and the second outer wall 34). The plurality of first elongated ridges 80 and the plurality of first elongated troughs 82 need not extend along an entire width of the base 12.

The plurality of first elongated troughs 82 may engage a surface 83 of the bottom wall 30 of the base 12. In various aspects, the plurality of first elongated troughs 82 may act as mounting flanges for coupling the first reinforcement 14 to the base 12. The first elongated ridges 80 and the first elongated troughs 82 may be alternatingly disposed such that the first elongated ridges 80 are disposed between the first elongated troughs 82. The first reinforcement 14 may include three first elongated ridges 80. However, in alternative aspects, the first reinforcement 14 may include greater than or equal to one and less than or equal to six first elongated ridges (1-6 first elongated ridges), optionally greater than or equal to two and less than or equal to five first elongated ridges (2-5 first elongated ridges), and optionally three (3) first elongated ridges.

As best shown in FIG. 1B, each first elongated ridge 80 may include a first side wall 84, a second side wall 86, and a top wall 88 extending between the first side wall 84 an the second side wall 86. Each of the first side wall 84 and the second side wall 86 may form a first angle 90 with the top wall 88. The first angle 90 may be greater than or equal to about 90° to less than 180°, optionally, greater than or equal to about 93° to less than or equal to about 135°, and optionally about 96°. The plurality of first elongated ridges 80 may cooperate with the bottom wall 30 of the base 12 to define a respective plurality of elongated cells 92. The plurality of elongated cells 92 may be open (i.e., filled with air). However, in alternative variations, the plurality of elongated cells 92 may be filled or partially filled with another material or component, such as an impact-resistant component.

Each first elongated ridge 80 may define a maximum height 94 and a maximum width 96. The maximum height 94 may be greater than or equal to about 25 mm to less than or equal to about 200 mm, optionally greater than or equal to about 50 mm to less than or equal to about 175 mm, and optionally greater than or equal to about 75 mm to less than or equal to about 150 mm. The maximum width 96 may be greater than or equal to about 75 mm to less than or equal to about 150 mm, and optionally greater than or equal to about 100 mm to less than or equal to about 125 mm. Although the first elongated ridges 80 are shown as having similar or identical heights, widths, and spacing, alternative configurations are possible.

The second reinforcement 16 may be similar to the first reinforcement 14. The second reinforcement 16 may include a third end wall 102 and a fourth end wall 104 similar to the first end wall 70 and the second end wall 72, respectively, of the first reinforcement 14. The third end wall 102 may engage the second outer wall 34 of the base 12. The fourth end wall 104 may engage the second inner wall 46 of the base 12. The second reinforcement 16 may include a third reinforcement flange 106 and a fourth reinforcement flange 108 that are similar to the first reinforcement flange 74 and the second reinforcement flange 76 of the first reinforcement 14, respectively. The third reinforcement flange 106 may project from the third end wall 102 away from the fourth end wall 104 and engage a second base flange 110 of the base 12. The second base flange 110 may project from the second outer wall 34 of the base 12 away from the first side 33 of the base 12. The fourth reinforcement flange 108 may engage the upper wall 48 of the base 12.

The second reinforcement 16 may include at least one second elongated ridge, which may be a plurality of second elongated ridges 112. Each second elongated ridge 112 may define and extend along a respective second transverse axis 113. The second reinforcement 16 may further include at least one second elongated trough, which may be a plurality of second elongated troughs 114. The plurality of second elongated ridges 112 and the plurality of second elongated troughs 114 may be similar to the plurality of first elongated ridges 80 and the plurality of first elongated troughs 82, respectively. The plurality of second elongated ridges 112 may therefore cooperate with the bottom wall 30 of the base 12 to define a respective plurality of second elongated cells (not shown).

Although the underbody assembly 10 includes two reinforcements (i.e., the first reinforcement 14 and the second reinforcement 16), one skilled in the art will appreciate that different quantities of reinforcements may be included in the underbody assembly 10 within the scope of the present disclosure. In one example, when the longitudinal tunnel 43 is omitted from the base 12, as discussed above, the underbody assembly 10 may include a single reinforcement extending between the first side 33 of the base 12 and the second side 35 of the base 12 (e.g., from the first outer wall 32 to the second outer wall 34). In another example, the underbody assembly 10 includes more than one reinforcement coupled to each of the first and second portions 56, 58 of the base 12 (e.g., a first reinforcement coupled to the first portion 56 and disposed adjacent to a first B-pillar, a second reinforcement coupled to the second portion 58 and disposed adjacent to a second B-pillar, a third reinforcement coupled to the first portion 56 and disposed adjacent to the front wall 36, and a fourth reinforcement coupled to the second portion 58 and disposed adjacent to the front wall 36). In yet another example, the underbody assembly 10 includes multiple reinforcements stacked on top of one another (e.g., in a direction substantially perpendicular to the longitudinal axis 52 and the first and second transverse axes 81, 113). In such an arrangement, respective pluralities of elongated ridges may be offset to define a honeycomb structure.

The first and second rocker subassemblies 18, 20 of the underbody assembly 10 may extend along respective first and second sides of the vehicle to absorb energy during side impacts. As best shown in FIG. 1C, the first rocker subassembly 18 may include a first housing 130 and at least one first energy-absorbing element, which may be a plurality of first energy-absorbing elements 132. The first housing 130 and the plurality of first energy-absorbing elements 132 may each be formed from or include a polymer-fiber composite material, such as those described above. The first housing 130 may include a first component 133 (the “first elongated rocker component”) and a second component 134 (the “second elongated rocker component”). The first component 133 may define a first elongated C-shaped body 135 and may include first outwardly extending flanges 136. The second component 134 may define a second elongated C-shaped body 137 and may include second outwardly-extending flanges 138. In various aspects, the first elongated C-shaped body 135 may define a greater thickness than the second elongated C-shaped body 137. Although the first housing 130 includes two components (i.e., the first component 133 and the second component 134), in various alternative aspects, the first housing 130 may include a unibody structure (e.g., when the first housing 130 is manufactured by a pultrusion process). The first and second components 133, 134 may cooperate to define a first interior compartment 140. The plurality of first energy-absorbing elements 132 may be disposed within the first interior compartment 140 and fixed to the first housing 130, such as to the first component 133.

The first energy-absorbing elements 132 may be discontinuous such that they do not share walls with one another. Each first energy-absorbing element 132 may include a respective elongated hollow structure 142 defining a central axis 144. Each elongated hollow structure 142 may extend between a first end 146 and a second end 148. The first end 146 may be coupled to the first component 133 of the first housing 130. Each elongated hollow structure 142 may define a substantially round cross section in a direction perpendicular to the central axis 144. By way of example, “substantially round” may include circles and ovals. In certain aspects, the first energy-absorbing elements 132 may optionally be substantially symmetric about the central axis 144.

Each elongated hollow structure 142 may include a first thickness 150 at the first end 146 and a second thickness 152 at the second end 148. The first thickness 150 and the second thickness 152 may be distinct. In various aspects, the second thickness 152 may be less than the first thickness 150. Thus, in certain side impact conditions, the second end 148 may be designed to crush prior to the first end 146. In one example, a thickness each elongated hollow structure 142 may be linearly tapered between the first end 146 and the second end 148.

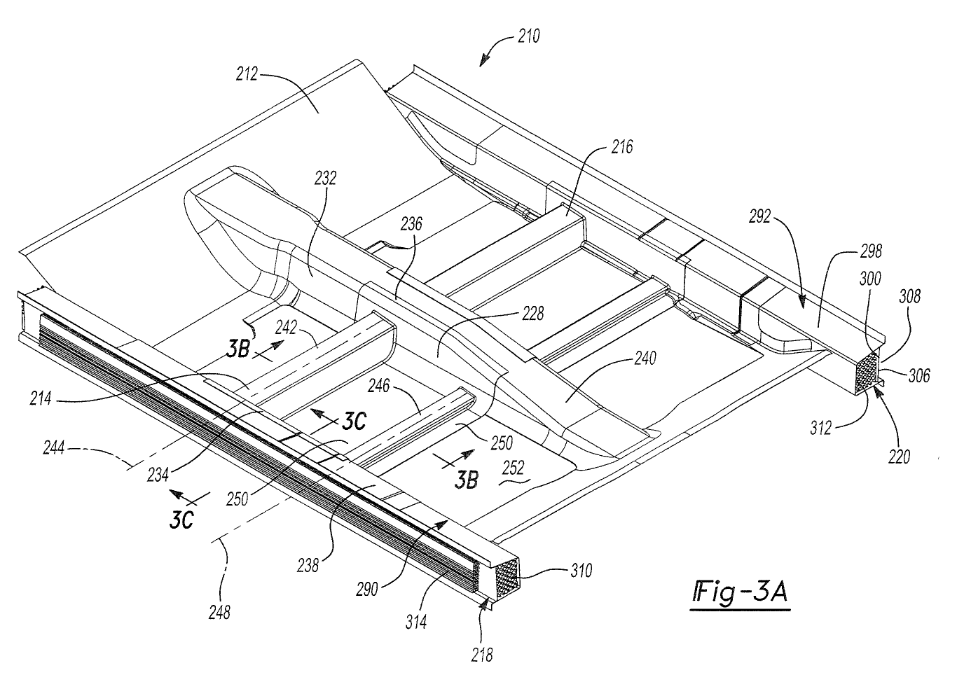

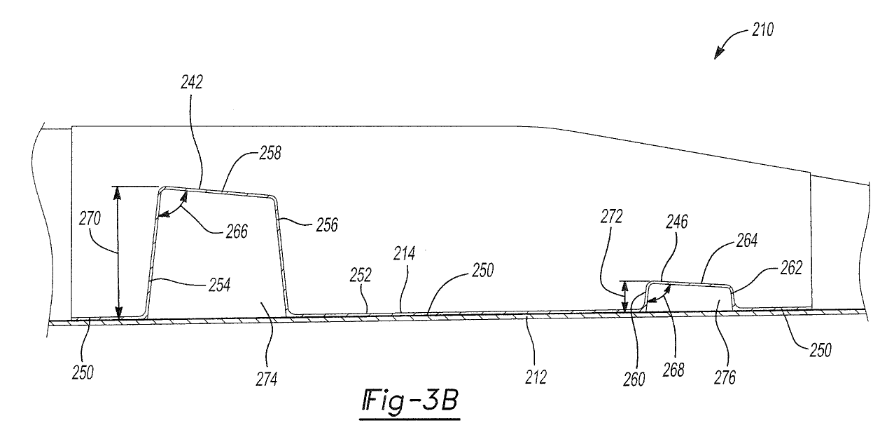

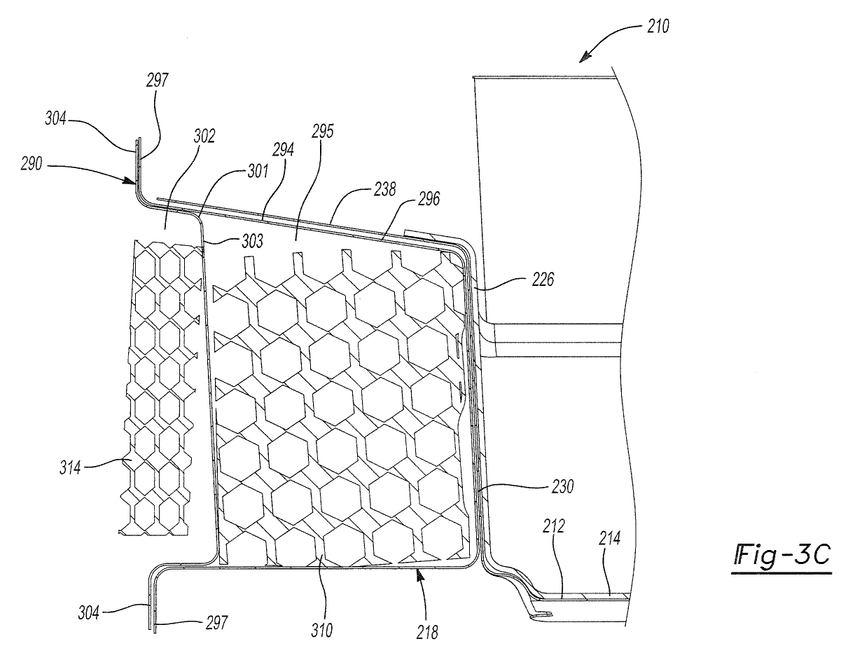

Returning to FIG. 1A, although the first rocker subassembly 18 includes the plurality of first energy-absorbing elements 132, one skilled in the art would appreciate that any other energy-absorbing element or elements that can perform adequately under anticipated load conditions may be included within the scope of the present disclosure. In one example, the first rocker subassembly 18 includes energy-absorbing elements having different geometries (e.g., length, diameter, wall thickness, material of construction), features (e.g., a flange for coupling the first energy-absorbing element 132 to the first housing 130), or arrangements (e.g., grouped together, grouped in smaller clusters, or spread apart from one another) within the first housing 130. In another example, the first rocker subassembly 18 includes a plurality of energy-absorbing elements, each of which include a transverse plate (e.g., a corrugated plate) extending between the first component 133 of the first housing 130 and the second component 134 of the first housing 130. In yet another example, the first rocker subassembly 18 includes a single energy-absorbing element, for example, having a honeycomb structure (see, e.g., first energy-absorbing element 310 of FIG. 3C).

The second rocker subassembly 20 may be similar to the first rocker subassembly 18. The second rocker subassembly 20 may include a second housing 160 and at least one second energy-absorbing element, which may be a plurality of second energy-absorbing elements (not shown). The second housing 160 may include a third component 162 (the “third elongated rocker component”) similar to the first component 133 of the first housing 130 and a fourth component 164 (the “fourth elongated rocker component”) similar to the second component 134 of the first housing 130. The third and fourth components 162, 164 may define a second interior compartment 166 similar to the first interior compartment 140 of the first housing 130. The plurality of second energy-absorbing elements may be similar to the plurality of first energy-absorbing elements 132 of the first rocker subassembly 18.

The first and second rocker subassemblies 18, 20 may be coupled to the base 12 so that they extend along respective first and second sides of the vehicle. The first rocker subassembly 18 may be coupled to the first side 33 of the base 12. The second rocker subassembly 20 may be coupled to the second side 35 of the base 12. More particularly, the first component 133 of the first housing 130 of the first rocker subassembly 18 may be coupled to the first base flange 78 and/or the first outer wall 32 of the base 12. The third component 162 of the second housing 160 of the second rocker subassembly 20 may be coupled to the second base flange 110 and/or the second outer wall 34 of the base 12. The first and second rocker subassemblies 18, 20 may be coupled to the base 12, for example, by adhesive. The first and second housings 130, 160 may optionally extend substantially parallel to the longitudinal axis 52 (i.e., the first and second housings 130, 160 may extend longitudinally).

The underbody assembly 10 may be coupled to the vehicle (not shown). When the underbody assembly 10 is coupled to the vehicle, seats of the vehicle may be coupled to the first reinforcement 14 and/or the second reinforcement 16. In certain aspects, the seats are directly coupled to the first elongated ridges 80 and/or the second elongated ridges 112. In one example, during manufacturing of the first and second reinforcements 14, 16, a structural seat component, such as a frame or insert, is at least partially disposed within a mold, and the reinforcement (such as the first reinforcement 14 or the second reinforcement 16) is molded around the structural seat component.

The first reinforcement 14 and the second reinforcement 16 may be arranged to provide structural support at certain areas of the vehicle. In one example, the plurality of first elongated ridges 80 of the first reinforcement 14 is disposed near a first B-pillar on the first side of the vehicle. The plurality of second elongated ridges 112 may be disposed near a second B-pillar on the second side of the vehicle. The first reinforcement 14 may be disposed to provide support to the first energy-absorbing elements 132. The second reinforcement 16 may be disposed to provide support to the second energy-absorbing elements (not shown). Thus, the first and second energy-absorbing elements 132 may remain coupled to the underbody assembly 10 during an impact for maximum energy absorption. In contrast, absent adequate structural support, the pluralities of first and second energy-absorbing elements may become detached from the underbody assembly 10 prior to maximum energy absorption during a loading event.

The first and second transverse axes 81, 113 may extend substantially perpendicular to the longitudinal axis 52 of the elongated raised portion 44. However, in various alternative aspects, the first and second transverse axes 81, 113 extend non-perpendicular to the longitudinal axis 52 so that the pluralities of first and second elongated ridges 80, 112 also extend non-parallel to the longitudinal axis 52. The first and second transverse axes 81, 113 may be oriented to optimize performance of the underbody assembly 10 during a side impact. Although each respective first transverse axis 81 is shown as being parallel to each other first transverse axis 81, in alternative aspects, the first transverse axes 81 may extend nonparallel to one another. Similarly, the respective second transverse axes 113 may extend nonparallel to one another.

The plurality of first energy-absorbing elements 132 of the first rocker subassembly 18 and the plurality of second energy-absorbing elements (not shown) of the second rocker subassembly 20 may be arranged to optimize performance of the underbody assembly 10 during a side impact. In one example, the plurality of first energy-absorbing elements 132 is disposed near the first B-pillar. The plurality of second energy-absorbing elements is disposed near the second B-pillar. As discussed above, the pluralities of first and second energy-absorbing elements 132 may be disposed near respective first and second reinforcements 14, 16.

Fiber architecture, including orientation of reinforcing fibers, in the polymer-fiber composite components may affect structural and impact performance of the underbody assembly 10. Fiber architecture in each of the polymer-fiber composite components (e.g., the base 12, the first reinforcement 14, the second reinforcement 16, the first component 133, the second component 134, the third component 162, the fourth component 164, the plurality of first energy-absorbing elements 132, and the plurality of second energy-absorbing elements (not shown) may be optimized to improve performance of the underbody assembly 10, for example, when subjected to an external load.

In an example, a first polymer-fiber composite of the base 12 includes a first multi-laminate structure. Second and third polymer-fiber composites of the first and second reinforcements 14, 16, respectively each include a second multi-laminate structure. In various aspects, the first fiber architecture and the second fiber architecture are distinct. The first and third components 133, 162 of the first and second rocker subassemblies 18, 20, respectively include fourth and fifth polymer-fiber composites, each having a third multi-laminate structure. The second and fourth components 134, 164 of the first and second rocker subassemblies 18, 20, respectively, include sixth and seventh polymer-fiber composites, each having a fourth multi-laminate structure. In various aspects, the third and fourth multi-laminate structures may be the same.

As previously described, underbody assemblies according to certain aspects of the present disclosure include a base (see, e.g., base 12) and at least one reinforcement (see, e.g., first reinforcement 14). Some underbody assemblies may also include one or more rocker subassemblies (see, e.g., first rocker subassembly 18). However, the specific geometries of each component may be optimized to meet structural, packaging, and loading requirements of the vehicle. Examples of base (FIGS. 2A-2B and 8-9), reinforcement (FIGS. 3A-7), and rocker subassembly (FIGS. 3A-3C and 8-9) variations are described below.

With reference to FIGS. 2A-2B, another base 180 according to certain aspects of the present disclosure is provided. The base 180 may be included in an underbody assembly having at least one reinforcement (e.g., the first reinforcement 14 of FIGS. 1A-1C) and first and second rocker subassemblies (e.g., first and second rocker subassemblies 18, 20 of FIGS. 1A-1C). The base 180 may include a first outer wall 182 and a second outer wall 184 similar to the first outer wall 32 and the second outer wall 34, respectively, of the base 12 of FIGS. 1A-1C. The base 180 may further include an elongated raised portion 186 similar to the elongated raised portion 44 of the base 12 of FIGS. 1A-1C. Unless otherwise described below, the base 180 may be similar to the base 12 of FIGS. 1A-1C.

The base 180 may define a variable thickness. The base 180 may include a first region 188, a second region 190, a third region 192, and a fourth region 194. The second region 190 may be at least partially disposed on the elongated raised portion 186, for example, near a center of the elongated raised portion 186 between the front and rear of the vehicle. The third region 192 may be at least partially disposed on the first outer wall 182. The fourth region 194 may be at least partially disposed on the second outer wall 184. The first region 188 may extend between the second, third, and fourth regions 190, 192, 194.

As best shown in FIG. 2B, the first region 188 may have a first thickness 196. The second region 190 may have a second thickness 198. The second thickness 198 may be distinct from the first thickness 196. For example, the second thickness 198 may be greater than the first thickness 196. The third region 192 may have a third thickness 200. The third thickness 200 may be distinct from the first thickness 196. For example, the third thickness 200 may be greater than the first thickness 196. The fourth region 194 may have a fourth thickness (not shown). The fourth thickness may be distinct from the first thickness 196. For example, the fourth thickness may be greater than the first thickness 196. The second, third, and fourth regions 190, 192, 194 may collectively be referred to as “thickened regions.”

The first thickness 196 may be greater than or equal to about 2 mm to less than or equal to about 10 mm, optionally greater than or equal to about 2.5 mm to less than or equal to about 7.5 mm, and optionally greater than or equal to about 2.5 mm to less than or equal to about 6 mm. The second, third, and fourth thicknesses 198, 200 may each be greater than or equal to greater than or equal to about 3 mm to less than or equal to about 15 mm, optionally greater than or equal to about 3 mm to less than or equal to about 10 mm, and optionally greater than or equal to about 3 mm to less than or equal to about 7.5 mm. The second, third, and fourth thickness 198, 200 may be the same or they may be different from one another. The thicknesses 196, 198, 200 need not be uniform across each region 188, 190, 192, 194. For example, an increase in thickness may be gradual. Therefore, in various aspects, the above thicknesses 196, 198, 200 may correspond to maximum thicknesses within each region.

The base 180 may be formed from or include a polymer-fiber composite material, such as those discussed above. In various aspects, the polymer-fiber composite may include different quantities of reinforcing fiber layers in each of the regions (e.g., the first region 188, the second region 190, the third region 192, and the fourth region 194). Fiber orientation in each of the regions may be the same. For example, the second, third, and fourth regions 190, 192, 194 may include additional layers of fabric as compared to the first region 188.

In general, thickened regions may be present in expected areas of relatively high stress concentration. As discussed above, in various aspects, an inclusion of thickened regions facilitates a reduction of the quantity of components in an underbody assembly (such as the underbody assembly 10 of FIGS. 1A-1C). Where a typical metal underbody assembly includes additional structural components at high-stress areas, the composite underbody assembly of the present disclosure may alternatively include the thickened regions at the high-stress areas. One skilled in the art will appreciate that the locations and sizes of the thickened regions may be tailored to expected loads on the underbody assembly. Thus, the first, second, third, and fourth regions 188, 190, 192, 194 are merely exemplary. Additionally or alternatively, thickened regions may be included on the reinforcements or the rocker subassemblies (e.g., on the housings).

Referring to FIGS. 3A-3C, another underbody assembly 210 according to certain aspects of the present disclosure is provided. The underbody assembly 210 may include a base 212, a first reinforcement 214, a second reinforcement 216, a first rocker subassembly 218, and a second rocker subassembly 220. The base 212 may be similar to the base 12 of the underbody assembly 10 of FIGS. 1A-1C.

As best shown in FIG. 3C, the first reinforcement 214 may include a first end wall 226 and a second end wall 228. The first end wall 226 may engage a first outer wall 230 of the base 212. The second end wall 228 may engage a first inner wall 232 of the base 212. The first reinforcement 214 may further include a first reinforcement flange 234 and a second reinforcement flange 236. The first reinforcement flange 234 may project from the first end wall 226 away from the second end wall 228. The second reinforcement flange 236 may project from the second end wall 228 away from the first end wall 226. The first reinforcement flange 234 may engage a first base flange 238 that extends from the first outer wall 230 of the base 212. The second reinforcement flange 236 may engage an upper wall 240 of the base 212.

The first reinforcement 214 may include a first elongated ridge 242 extending along a first transverse axis 244 and a second elongated ridge 246 extending along a second transverse axis 248. The first reinforcement 214 may further include a plurality of first elongated troughs 250 disposed between the elongated ridges 242, 246. The plurality of first elongated troughs 250 may engage a surface 252 of the base 212. In various aspects, the first elongated troughs 250 may act as flanges to couple the first reinforcement 214 to the base 212.

As best shown in FIG. 3B, the first elongated ridge 242 may include a first side wall 254, a second side wall 256, and a first top wall 258. The second elongated ridge 246 may include a third side wall 260, a fourth side wall 262, and a second top wall 264. A first angle 266 may be defined between the first side wall 254 and the first top wall 258. A second angle 268 may be defined between the third side wall 260 and the second top wall 264. In various aspects, the first and second angles 266, 268 may each be greater than or equal to about 90° to less than or equal to about 120°. The first and second angles 266, 268 may be the same or different.

The first elongated ridge 242 may define a first maximum height 270. The second elongated ridge 246 may define a second maximum height 272. The first and second maximum heights 270, 272 may be distinct. For example, the first maximum height 270 may be greater than the second maximum height 272. The first elongated ridge 242 may cooperate with the base 212 to define a first elongated cell 274. The second elongated ridge 246 may cooperate with the base 212 to define a second elongated cell 276. The second reinforcement 216 may be similar to the first reinforcement 214.

Returning to FIGS. 3A and 3C, the first rocker subassembly 218 may include a first housing 290 and the second rocker subassembly 220 may include a second housing 292. As will be described below, each of the first and second housings 290, 292 may be subdivided to house energy-absorbing elements with different crush properties. The first housing 290 may include a first component 294 at least partially defining a first interior compartment 295. The first component 294 may define a first elongated C-shaped body 296 and first outwardly-extending flanges 297. The second housing 292 may include a second component 298 at least partially defining a second interior compartment 300 (FIG. 3A). The second component 298 of the second housing 292 may be similar to the first component 294 of the first housing 290. The first housing 290 may further include a third component 301 at least partially defining a third interior compartment 302. The third component 301 may define a second elongated C-shaped body 303 and include second outwardly-extending flanges 304. The first and third components 294, 301 may be coupled to one another at or near the first and second outwardly-extending flanges 297, 304. The second housing 292 may further include a fourth component 306 at least partially defining a fourth interior compartment 308. The fourth component 306 may be similar to the second component 298. A first energy-absorbing element 310 may be disposed within the first interior compartment 295. A second energy-absorbing element 312 may be disposed within the second interior compartment 300. A third energy-absorbing element 314 may be disposed within the third interior compartment 302. A fourth energy-absorbing element (not shown) may be disposed within the fourth interior compartment 308.

As best shown in FIG. 3C, the first and third energy-absorbing elements 310, 314 may define honeycomb structures. The first housing 290 may further include a fifth component (not shown) coupled to the third component 301 to enclose the third interior compartment 302. The second housing 292 may further include a sixth component (not shown) coupled to the fourth component 306 to enclose the fourth interior compartment 308. Although each interior compartment 295, 300, 302, 308 includes a respective single energy-absorbing element 310, 312, 314, alternative energy-absorbing elements may be used. For example, the first energy-absorbing element 310 may be replaced with a plurality of discrete energy-absorbing elements (see, e.g., the plurality of first energy-absorbing elements 132 of FIGS. 1A-1C).

The first rocker subassembly 218 including the first and third energy-absorbing elements 310, 314 may be subdivided for low- and high-energy impacts. For example, a low impact may cause the third energy-absorbing element 314 to crush while leaving the first energy-absorbing element 310 intact. Subdividing the first rocker subassembly 218 may advantageously allow for only a partial replacement or repair of the first rocker subassembly 218. For example, where only the third energy-absorbing element 314 is damaged in a low-impact event, the third component 301 and the third energy-absorbing element 314 (and the fifth component, if present) can be repaired or replaced independent of the first component 294 and first energy-absorbing element 310. The second rocker subassembly 220 may be similar to the first rocker subassembly 218.

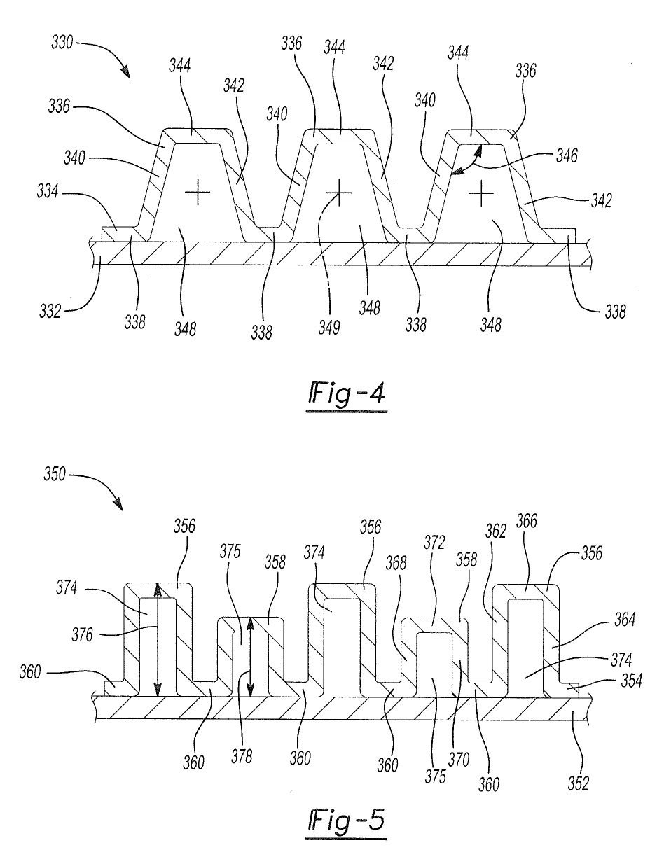

As discussed above, a reinforcement according to certain aspects of the present disclosure includes one or more elongated ridges. The elongated ridges may define a variety of shapes and sizes. Referring to FIG. 4, a partial underbody assembly 330 according to certain aspects of the present disclosure is provided. The underbody assembly 330 may include a base 332 and a reinforcement 334. Unless otherwise described, the base 332 and reinforcement 334 may be similar to the base 12 and first reinforcement 14 of the underbody assembly 10 of FIGS. 1A-1C, respectively.

The reinforcement 334 may include at least one elongated ridge, which may be a plurality of elongated ridges 336 and one or more elongated troughs, which may be a plurality of elongated troughs 338. Each elongated ridge 336 may be disposed adjacent to an elongated trough 338, so that the elongated ridges 336 and the elongated troughs 338 are alternatingly disposed. Each elongated ridge 336 may include a first side wall 340, a second side wall 342, and a top wall 344. An angle 346 may be formed between the top wall 344 and each of the first and second side wall 340, 342. In certain aspects, the angle is greater than or equal to about 91° and less than or equal to about 135°. The plurality of elongated ridges 336 may cooperate with the base 332 to define a plurality of elongated cells 348. Each elongated cell 348 may define a substantially trapezoidal cross section in a direction perpendicular to a transverse axis 349 of the elongated ridge 336.

With reference to FIG. 5, another partial underbody assembly 350 according to certain aspects of the present disclosure is provided. The underbody assembly 350 may include a base 352 and a reinforcement 354. Unless otherwise described, the base 352 and reinforcement 354 may be similar to the base 12 and first reinforcement 14 of the underbody assembly 10 of FIGS. 1A-1C, respectively.

The reinforcement 354 may include at least one first elongated ridge, which may be a plurality of first elongated ridges 356, at least one second elongated ridge, which may be a plurality of second elongated ridges 358, and at least one elongated trough, which may be a plurality of elongated troughs 360. Each first elongated ridge 356 may include a first side wall 362, a second side wall 364, and a first top wall 366. The first and second side walls 362, 364 may each be substantially perpendicular to the first top wall 366. Each second elongated ridge 358 may include a third side wall 368, a fourth side wall 370, and a second top wall 372. The third and fourth side walls 368, 370 may each be substantially perpendicular to the second top wall 372. The plurality of first elongated ridges 356 may cooperate with the base 352 to define a plurality of first elongated cells 374. The plurality of second elongated ridges 358 may cooperate with the base 352 to define a second plurality of elongated cells 375. Each of the first and second elongated cells 374, 375 may define a substantially rectangular cross section.

Each first elongated ridge 356 may define a first height 376. Each second elongated ridge 358 may define a second height 378. The first and second heights 376, 378 may be distinct. For example, the first height 376 may be greater than the second height 378.

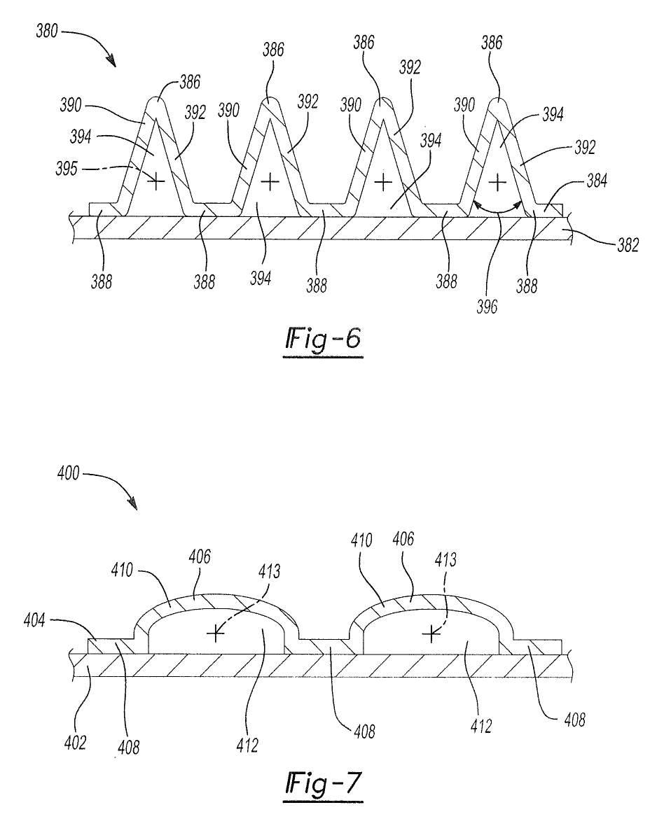

Referring to FIG. 6, yet another partial underbody assembly 380 according to certain aspects of the present disclosure is provided. The underbody assembly 380 may include a base 382 and a reinforcement 384. Unless otherwise described, the base 382 and reinforcement 384 may be similar to the base 12 and first reinforcement 14 of the underbody assembly 10 of FIGS. 1A-1C, respectively.

The reinforcement 384 may include at least one elongated ridge, which may be a plurality of elongated ridges 386 and at least one elongated trough, which may be a plurality of elongated troughs 388. Each elongated ridge 386 may be disposed adjacent to an elongated trough 388, so that that elongated ridges 386 and the elongated troughs 388 are alternatingly disposed. Each elongated ridge 386 may include a first side wall 390 and a second side wall 392. The plurality of elongated ridges 386 may cooperate with the base 382 to define a plurality of elongated cells 394. Each elongated cell 394 may have a substantially triangular cross section in a direction perpendicular to a transverse axis 395 of the elongated ridge 386. The first side wall 390 and the second side wall 392 may define an angle 396. The angle 396 may be greater than 0° to less than 180°, optionally, greater than or equal to about 30° to less than or equal to about 135°, optionally, greater than or equal to about 45° to less than or equal to about 110° and optionally, greater than or equal to about 60° to less than or equal to about 90°.

With reference to FIG. 7, yet another partial underbody assembly 400 according to certain aspects of the present disclosure is provided. The underbody assembly 400 may include a base 402 and a reinforcement 404. Unless otherwise described, the base 402 and reinforcement 404 may be similar to the base 12 and first reinforcement 14 of the underbody assembly 10 of FIGS. 1A-1C, respectively.

The reinforcement 404 may include at least one elongated ridge, which may be a plurality of elongated ridges 406 and at least one elongated trough, which may be a plurality of elongated troughs 408. Each elongated ridge 406 may be adjacent to an elongated trough 408, so that the elongated ridges 406 and the elongated troughs 408 are alternatingly disposed. Each elongated ridge 406 may include a wall 410. The wall 410 may be rounded. The plurality of elongated ridges 406 may cooperate with the base 402 to define a plurality of elongated cells 412. Each elongated cell 412 may define a cross section has a semi-circular or semi-ovular shape in a direction perpendicular to a transverse axis 413 of the elongated ridge 406.

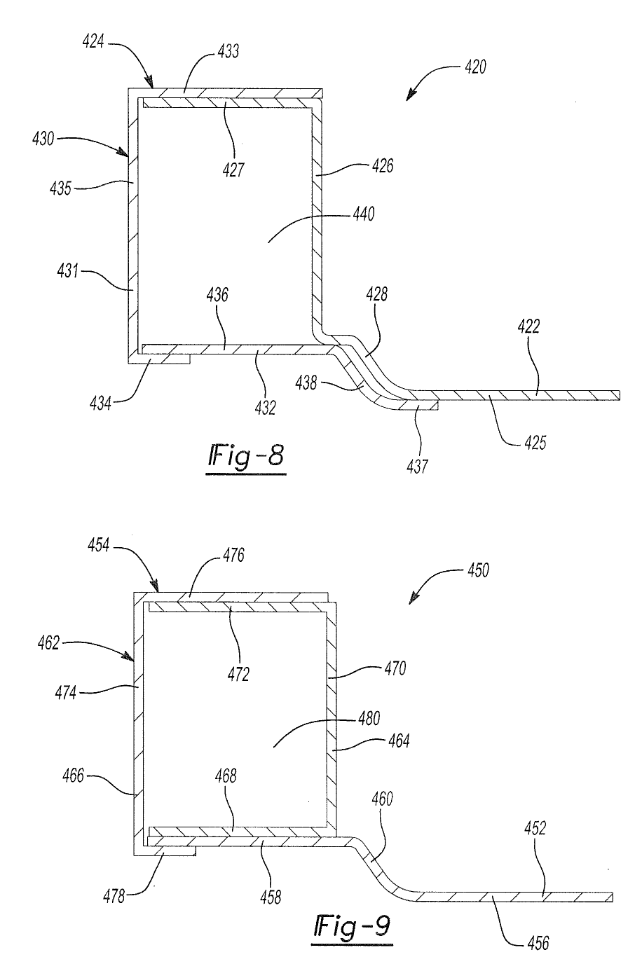

In various aspects, an underbody assembly according to certain aspects of the present disclosure includes a base that forms a portion of a rocker subassembly and/or is coupled to the rocker subassembly in a different manner than described above with respect to FIGS. 1A-1C. Referring to FIG. 8, a partial underbody assembly 420 according to certain aspects of the present disclosure is provided. The underbody assembly 420 may include a base 422 and a rocker subassembly 424. Unless otherwise described, the base 422 and rocker subassembly 424 may be similar to the base 12 and first rocker subassembly 18 of the underbody assembly 10 of FIGS. 1A-1C, respectively. The underbody assembly 420 may further include one or more reinforcements (see, e.g., first reinforcement 14 of FIGS. 1A-1C).

The base 422 may include a bottom wall 425, an inner wall 426, and a first upper wall 427. A first angled wall 428 may extend between the bottom wall 425 and the inner wall 426. The rocker subassembly 424 may include a housing 430 including a first component 431 and a second component 432. The first component 431 may include a second upper wall 433, a flange 434, and an outside wall 435. The second component 432 may include a bottom wall 436, a lip 437, and a second angled wall 438 extending between the bottom wall 436 and the lip 437. The first component 431, the second component 432, the inner wall 426, the first upper wall 427, and the second upper wall 433 may cooperate to at least partially define an interior compartment 440 of the rocker subassembly 424. At least one energy-absorbing element (see, e.g., the plurality of first energy-absorbing elements 132 of FIGS. 1A-1C or the first energy-absorbing element 310 FIGS. 3A-3C) may be disposed within the interior compartment 440.

With reference to FIG. 9, another partial underbody assembly 450 according to certain aspects of the present disclosure is provided. The underbody assembly 450 may include a base 452 and a rocker subassembly 454. Unless otherwise described, the base 452 and rocker subassembly 454 may be similar to the base 12 and first rocker subassembly 18 of the underbody assembly 10 of FIGS. 1A-1C, respectively. The underbody assembly 450 may further include one or more reinforcements (see, e.g., first reinforcement 14 of FIGS. 1A-1C).

The base 452 may include a bottom wall 456, an outwardly-extending wall 458, and an angled wall 460 extending between the bottom wall 456 and the outwardly-extending wall 458. The rocker subassembly 454 may include a housing 462 having a first component 464 and a second component 466. The first component 464 may include a first or bottom wall 468, a second or inner wall 470, and a third or upper wall 472. The second wall 470 may extend between the first wall 468 and the third wall 472. The second component 466 may include a fourth or outer wall 474, a fifth or top wall 476, and a bottom wall or flange 478. The fourth wall 474 may extend between the fifth wall 476 and the flange 478. The second wall 470, the third wall 472, the fourth wall 474, and the fifth wall 476 may cooperate to at least partially define an interior compartment 480 of the rocker subassembly 454. At least one energy-absorbing element (see, e.g., the plurality of first energy-absorbing elements 132 of FIGS. 1A-1C or the first energy-absorbing element 310 FIGS. 3A-3C) may be disposed within the interior compartment 480. The housing 462 may be coupled to the base 452. More particularly, the first wall 468 of the housing 462 may engage the outwardly-extending wall 458 of the base 452. The flange 478 of the housing 462 may engage the outwardly-extending wall 458 of the base 452.

Any of the underbody assemblies and subassemblies discussed herein may be used on a vehicle. The methodology described herein, including consolidating structural components in a variable-thickness composite structure and adhesively coupling strategically-placed reinforcements, may be similarly applicable to other structural components, such as engine cradles and transmission carriers. Although automotive applications are generally discussed, the underbody assemblies may also be used in other applications such as other vehicle applications (e.g., motorcycles and recreational vehicles), in the aerospace industry (e.g., airplanes, helicopters, drones), nautical applications (e.g., ships, personal watercraft, docks), agricultural equipment, industrial equipment, and the like.

In various aspects, the present disclosure also provides a method of manufacturing an underbody assembly according to certain aspects of the present disclosure. The method is discussed with respect to the underbody assembly 10 of FIGS. 1A-1C, however, one skilled in the art will appreciate that the method is similarly applicable to the other underbody assemblies and components (e.g., bases, reinforcements, and rocker subassemblies) described herein.

The method may include forming the base 12, the first reinforcement 14, the second reinforcement 16, the first and second components 133, 134 of the first housing 130, the plurality of first energy-absorbing elements 132, the third and fourth components 162, 164 of the second housing 160, and the plurality of second energy-absorbing elements. Each of the base 12, the first reinforcement 14, the second reinforcement 16, the first component 133, the second component 134, the plurality of first energy-absorbing elements 132, the third component 162, the fourth component 164, and the plurality of second energy-absorbing elements may be formed in a composite manufacturing process independently selected from the group consisting of: resin transfer molding (RTM), high-pressure resin transfer molding (HP-RTM), compression resin transfer molding (C-RTM), vacuum assisted resin transfer molding (VARTM), compression molding, autoclave molding, out-of-autoclave molding, and combinations thereof. In various aspects, the composite manufacturing processes, and particularly resin transfer molding (RTM), high-pressure resin transfer molding (HP-RTM), compression resin transfer molding (C-RTM), vacuum assisted resin transfer molding (VARTM), and compression molding may facilitate high-volume production of the various underbody assembly components.

In various aspects, forming the first and second reinforcements 14, 16 may optionally include disposing a structural seat component at least partially within a mold and forming the respective first reinforcement 14 or second reinforcement 16 around the structural component. Thus, the structural seat component may be securely coupled to the first reinforcement 14 or the second reinforcement 16. The first and second reinforcements 14, 16 may be coupled to the base 12 as described below, thereby also coupling the structural seat component to the base 12.

The first and second reinforcements 14, 16 may be adhesively joined to the base 12. Adhesive may be disposed between the base 12 and one or more of: the first reinforcement flange 74, the first end wall 70, the plurality of first elongated troughs 82, the second end wall 72, and the second reinforcement flange 76 to couple the first reinforcement 14 to the base 12. Adhesive may be disposed between the base 12 and one or more of: the third reinforcement flange 106, third end wall 102, the plurality of second elongated troughs 114, the fourth end wall 104, and the fourth reinforcement flange 108 to couple the second reinforcement 16 to the base 12. The adhesive may include adhesives based on methacrylate resins, urethane resins, or epoxy resins, by way of example. Additionally or alternatively, mechanical fasteners may be used.

The first and second rocker subassemblies 18, 20 may be coupled to the base 12 and/or the respective first and second reinforcements 14, 16. In one example, the first component 133 of the first housing 130 is adhesively coupled to one or more of the first base flange 78 and the first outer wall 32. The third component 162 of the second housing 160 is adhesively coupled to at least one of the second base flange 110 and the second outer wall 34. Additionally, in the case of a thermoplastic polymeric assembly, joining methods such as vibration welding, hot plate welding, and/or ultrasonic welding may be used.

The plurality of first energy-absorbing elements 132 and the plurality of second energy-absorbing elements may be adhesively coupled to the first and third components 133, 162, respectively. The second and fourth components 134, 164 may be coupled to the first and third components 133, 162, respectively, to form the first and second rocker subassemblies 18, 20. In one example, the first and second rocker subassemblies 18, 20 may be fully assembled prior to coupling the first and second rocker subassemblies 18, 20 to the base 12 (i.e., the plurality of first energy-absorbing elements 132 is disposed within the first interior compartment 140 formed by the first and third components 133, 162, and the plurality of second energy-absorbing elements is fixed within the second interior compartment defined by the second and fourth components 134, 164). In another example, the first and third components 133, 162 may be coupled to the base 12 prior to assembling the first and second rocker subassemblies 18, 20.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An underbody assembly for a vehicle comprising:
polymer-fiber composite components, the components comprising:
a base comprising a first side and a second side, the base being configured to extend in a longitudinal direction between a front of the vehicle and a rear of the vehicle; and
a first reinforcement being coupled to the base and comprising a first elongated ridge and a first elongated trough disposed adjacent to the first elongated ridge, the first elongated ridge and the first elongated trough each extending transversely between the first side of the base and the second side of the base.

2. The underbody assembly of claim 1, wherein the first elongated trough engages a surface of the base, and the first elongated ridge cooperates with the surface to define an elongated cell, the elongated cell being disposed between the first elongated ridge and the base.

3. The underbody assembly of claim 1, wherein the base includes a first region defining a first thickness and a second region defining a second thickness, the second thickness being greater than the first thickness.

4. The underbody assembly of claim 1, wherein:
the polymer-fiber composite of the base comprises a first fiber architecture; and
the polymer-fiber composite of the first reinforcement comprises a second fiber architecture that is distinct from the first fiber architecture.

5. The underbody assembly of claim 1, wherein the base further comprises an elongated raised portion disposed between a first portion of the base and a second portion of the base, the elongated raised portion defining a longitudinal tunnel extending in the longitudinal direction.

6. The underbody assembly of claim 5, wherein:
the first elongated ridge and the first elongated trough each extend between the first side of the base and the elongated raised portion; and
the polymer-fiber composite components further comprise a second reinforcement, the second reinforcement being coupled to the base and comprising a second elongated ridge and a second elongated trough being disposed adjacent to the second elongated ridge, the second elongated ridge and the second elongated trough each extending transversely between the elongated raised portion and the second side of the base.

7. The underbody assembly of claim 1, wherein:
the first reinforcement further comprises a first end wall, a second end wall, a first reinforcement flange, and a second reinforcement flange;
the first elongated ridge and the first elongated trough each extend between the first end wall and the second end wall; and
the first reinforcement flange projects from the first end wall and the second reinforcement flange projects from the second end wall, the first reinforcement flange and the second reinforcement flange engaging the base to couple the first reinforcement to the base.

8. The underbody assembly of claim 1, wherein the first elongated ridge is configured to be coupled to a seat of the vehicle.

9. The underbody assembly of claim 1, wherein:
the first elongated ridge comprises a plurality of first elongated ridges, the plurality of first elongated ridges comprising 1-6 first elongated ridges; and
the first elongated trough comprises a plurality of first elongated troughs, the first elongated troughs being alternatingly disposed with the first elongated ridges in the longitudinal direction.

10. The underbody assembly of claim 1, wherein the polymer-fiber composite components further comprise:
a first rocker subassembly coupled to the first side of the base, the first rocker subassembly comprising a first elongated housing defining a first interior compartment and a first energy-absorbing element disposed within the first interior compartment; and
a second rocker subassembly coupled to the second side of the base, the second rocker subassembly comprising a second elongated housing defining a second interior compartment and a second energy-absorbing element disposed within the second interior compartment.

11. The underbody assembly of claim 10, wherein:
the first energy-absorbing element comprises a plurality of first energy-absorbing elements, each first energy-absorbing element comprising a first elongated hollow structure defining a substantially round cross section; and
the second energy-absorbing element comprises a plurality of second energy-absorbing elements, each second energy-absorbing element comprising a second elongated hollow structure defining a substantially round cross section.

12. The underbody assembly of claim 10, wherein:
the first rocker subassembly further comprises a third energy-absorbing element and the first elongated housing further defines a third interior compartment, the third energy-absorbing element being disposed within the third interior compartment; and
the second rocker subassembly further comprises a fourth energy-absorbing element and the second elongated housing further defines a fourth interior compartment, the fourth energy-absorbing element being disposed within the fourth interior compartment.

13. The underbody assembly of claim 1, wherein the base and the first reinforcement comprise distinct polymer-fiber composite materials.

14. The underbody assembly of claim 1, wherein the polymer-fiber composites of the base and the first reinforcement each comprise multiaxial continuous fiber non-crimp fabrics.

15. An underbody assembly for a vehicle consisting essentially of:
polymer-fiber composite components, the components comprising:
a base configured to extend in a longitudinal direction between a front of the vehicle and a rear of the vehicle, the base comprising a first side, a second side, and an elongated raised portion defining a longitudinal tunnel and extending in the longitudinal direction between the front of the vehicle and the rear of the vehicle, the base including a first region defining a first thickness and a second region defining a second thickness greater than the first thickness;
a first rocker subassembly coupled to the first side of the base and comprising a first elongated housing defining a first interior compartment and a first energy-absorbing element disposed within the first interior compartment; and
a second rocker subassembly coupled to the second side of the base and comprising a second elongated housing defining a second interior compartment and a second energy-absorbing element disposed within the second interior compartment.

16. The underbody assembly of claim 15, wherein the second region is at least partially disposed on the elongated raised portion and the base further includes a third region and a fourth region, the third region having a third thickness greater than the first thickness and being disposed adjacent to the first side of the base and the fourth region having a fourth thickness greater than the first thickness and being disposed adjacent to the second side of the base.

17. A method of manufacturing an underbody assembly for a vehicle, the method comprising:
forming a base comprising a polymer-fiber composite, the base comprising a first side and a second side, and being configured to extend in a longitudinal direction between a front of the vehicle and a rear of the vehicle;
forming a reinforcement comprising a polymer-fiber composite, the reinforcement comprising an elongated ridge and an elongated trough disposed adjacent to the elongated ridge; and
coupling the reinforcement to the base so that the elongated ridge extends transversely between the first side of the base and the second side of the base.

18. The method of claim 17, wherein the coupling the reinforcement to the base includes disposing a layer of adhesive between the base and the reinforcement, and curing the adhesive.

19. The method of claim 17, wherein the forming the base and the forming the reinforcement each comprise a process selected from the group consisting of: resin transfer molding (RTM), high-pressure resin transfer molding (HP-RTM), compression resin transfer molding (C-RTM), vacuum assisted resin transfer molding (VARTM), compression molding, autoclave, and combinations thereof.

20. The method of claim 17, further comprising:
forming a first elongated rocker component, a second elongated rocker component, a third elongated rocker component, and a fourth elongated rocker component;
coupling the first elongated rocker component to the first side of the base;
coupling the second elongated rocker component to the second side of the base;
coupling the third elongated rocker component to the first elongated rocker component, the first elongated rocker component and the third elongated rocker component cooperating to define a first interior compartment; and
coupling the fourth elongated rocker component to the second elongated rocker component, the second elongated rocker component and the fourth elongated rocker component cooperating to define a second interior compartment.
